(19) United States
(12) Patent Application Publication
(10) Pub. No.: US 2003/0090526 A1
(43) Pub. Date: May 15, 2003

(54) Analysis work support system

(76) Inventors: Ichiro Nishigaki, Ishioka (JP); Makoto Onodera, Tsuchiura (JP); Norihiko Nonaka, Chiyoda (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 10/289,175

(22) Filed: Nov. 7, 2002

(30) Foreign Application Priority Data
Nov. 13, 2001 (JP) 2001-346844

(51) Int. Cl. G09G 5/00

(52) U.S. Cl. 345/810

(57) ABSTRACT

Analysis work processses are defined as a process template and an engineering tool and a knowledge retrieval visualization tool are combined by means of the process template. Further, the engineering tool automatically executes an execution control file corresponding to analysis knowledge. Thus, automation concerning analysis modeling and analysis evaluation of the analysis work can be realized.

### BACKGROUND OF THE INVENTION

The present invention relates to technique related to a Computer Aided Engineering (CAE) system that automates and optimizes design work by means of a numerical analysis simulation using a computer, and more particularly to analysis work support technique for leading or automating a complicated analysis work procedure by means of analysis modeling knowhow or analysis result evaluation knowhow.

Analysis work in case where the numerical analysis simulation is made generally performs a series of operations including preparation of an analysis model composed of analysis mesh and analysis conditions from a definition of a shape model of an object to be analyzed, execution of an analysis program, visualization and evaluation of analysis result by sequentially utilizing a plurality of programs including a prepost processor, analysis programs and the like. As methods of effectively performing the analysis work by utilizing the analysis modeling knowhow and the analysis result evaluation knowhow (hereinafter referred to as analysis knowledge), there are two methods as follows.

The first method utilizes a customized tool provided by the prepost processor to customize the prepost processor to the procedure conformed to the analysis work for each object to be analyzed to thereby construct a dedicated system. When the prepost processor is customized to the operation method conformed to the analysis procedure, the analysis knowledge is embedded therein in the form of programs and data to thereby automate the analysis work and display the analysis knowledge on an operation screen at a necessary view. This is described in a product catalogue of Analysis Process Construction Support Tool MSC/Acumen of MSC Inc.

The second method is a method in which a plurality of programs are connected to automate a series of analysis work. In the second method, data necessary for connection is extracted from input/output files of the programs and the data is transferred between the programs. Particularly, this method is used as measures for automating an optimum calculation process that changes an analysis model on the basis of an analysis result. In this case, analysis knowledge is required to be incorporated as an evaluation function program that evaluates the analysis result. This is described in a product catalogue of Design Integration and Optimum Support Software iSIGHT of Engineous Inc.

The conventional analysis work support system utilizing the analysis knowledge has the following problems.

In the first method, the customized tool provided by a specific prepost processor is used to previously construct one dedicated system for each object to be analyzed on the basis of the analysis process and the analysis knowledge. Accordingly, it is very difficult to make modification of the system such as rearrangement of analysis process and improvement of the system to similar analysis process when the system is used. Consequently, there is a problem that it takes time and labor to develop the system for each object to be analyzed.

The second method is suitable for optimization calculation for sequentially executing a plurality of programs in the fully automated manner on condition that individual programs to be executed can be processed in a fully automated manner. Consequently, the analysis knowledge is also required to be prepared as a program that can be processed automatically, and the analysis knowledge capable of being applied thereto is limited. For example, it is difficult for analysis knowledge selected to be utilized by decision of a system user from some knowledge to construct the system according to the present method. Accordingly, this method is not suitable for construction of an interactive-type analysis work support system utilizing the analysis knowledge.

That is, both of the conventional techniques have a problem that it is difficult to construct the analysis work system newly. Further, both of the conventional techniques are also the system that produces an analysis result in response to input and accordingly cannot adjust deficiency in use of a software itself concerning the analysis registered in the system.

### BRIEF SUMMARY OF THE INVENTION

It is a first object to provide an analysis work support system which can construct an analysis work system relatively simply and newly.

Further, it is a second object of the present invention to provide an analysis work support system which can implement an analysis support system constructed by the analysis work support system which attains the first object.

Moreover, it is a third object of the present invention to provide an analysis work support system which can adjust deficiency in use of software itself concerning analysis registered in the system.

The first object is achieved by the provision of a function of inputting a plurality of unit processes relative to the analysis work in accordance with the order intended by the preparation person and a function of inputting an engineering tool relative to the analysis work for each unit process.

The second object is achieved by the provision of a function of storing a plurality of unit processes displayed on a process template display view and storage addresses of work result data by a tool in which a program storage address is stored for each unit process and a function of, when a tool in a unit process next thereto is executed, providing to said tool in said next unit process an address in which said work result data by said tool is stored.

The third object is achieved by the provision of the function of storing a plurality of unit processes displayed on a process template display view and storage addresses of work history and work result data by a tool in which a program storage address is stored for each unit process and a function of, when a tool in a unit process next thereto is executed, providing to said tool in said next unit process an address in which said work result data by said tool is stored.

Other objects, features and advantages of the invention will become apparent from the following description of the embodiments of the invention taken in conjunction with the accompanying drawings.

### BRIEF DESCRIPTION OF THE SEVERAL VIEWS OF THE DRAWING

FIG. 1 is a schematic diagram illustrating a system according to an embodiment of the present invention;

FIG. 2 is a diagram illustrating an example of a process template;

FIGS. 3A, 3B and 3C are diagrams illustrating an example of a data structure of the process template;

FIG. 4 is a diagram illustrating relation between the process template and an engineering tool;

FIG. 5 is a diagram illustrating relation between the process template and a knowledge retrieval visualization tool;

FIG. 6 is a diagram illustrating preparation of the process template;

FIG. 7 is a diagram illustrating preparation of the process template;

FIG. 8 is a diagram illustrating preparation of the process template;

FIG. 9 is a diagram illustrating execution and control of the process template;

FIG. 10 is a diagram illustrating execution and control of the process template;

FIG. 11 is a diagram illustrating execution and control of the process template;

FIG. 12 is a diagram illustrating execution and control of the process template;

FIG. 13 is a diagram illustrating execution and control of the process template;

FIG. 14 is a flowchart showing operation of a process template preparation unit; and

FIG. 15 is a flowchart showing operation of a process template execution control unit.

### DETAILED DESCRIPTION OF THE INVENTION

What system is constructed is now described before an embodiment of the present invention is described. The system is constituted by two programs. The first is a process template preparation unit and the second is a process template execution control unit.

The process template preparation unit of the former is software for supporting that a template preparation person decides work items, the work order of the work items and programs to be used in the work items (tools programmed and necessary for the work items), registers the tools in relation to the work items and registers the work items in accordance with the work order. Even in the strength analysis of a structure, in most cases, work items, tools to be used and work order are different depending on the structure to be analyzed. For example, techniques for the strength analysis of a building and for the stress analysis of a semiconductor package are different. Further, it can be easily imagined that the strength analysis and the flow analysis of liquid are naturally different in procedure and tools to be used. The aforementioned first method is directed to the software customized fully for each object to be analyzed. Accordingly, when the object to be analyzed is changed, new software must be sought and cannot be prepared easily.

The process template preparation unit of the embodiment is an analysis apparatus preparation support system with which the template preparation person can prepare an analysis support system for a certain object to be analyzed, relatively simply as if a homepage having contents in which several links are set were prepared, for example. It is supposed that the template preparation person decides analysis work items, tools to be used in the analysis work items and analysis work procedure for a certain object to be analyzed. The template preparation person presses a template preparation button on a view and opens a template preparation view. In the template preparation view, a name of an analysis work item to be performed first is inputted as “Preparation of Shape Model”, for example. A view for selecting a tool to be used is displayed in response to the input and a previously registered tool (connected through a line and set in a usable environment) is selected. For example, if “CAD-A” is selected from a pull-down menu, the work item and the selected tool are registered in the linked manner to each other. Then, a name of an analysis work item at a next work procedure is inputted as “Preparation of Analysis Model”, for example. A view for selecting a tool to be used is displayed in a similar manner to above and when “Analysis Tool B”, for example, is selected from the pull-down menu, the tool is linked to the work item to be stored. Then, all of the work items are inputted in order in a similar manner to thereby construct the system which analyzes a desired object to be analyzed simply.

The process template execution control unit of the latter is software for executing the process template prepared by the template preparation person. That is, a process template user employs a tool given for each work item in the order of the work items prepared by the template preparation person to execute a work object suitable for the template.

When analysis is taken as an example, the process template prepared by the template preparation person becomes the analysis support system for the person who performs the analysis. The analysis executor opens the process template suitable for an object to be analyzed. Here, it is supposed that the process template prepared above is used. Since the analysis work items of the process template are described in an ascending order in accordance with the work procedure, a folder named “Preparation of Shape Model” at the highest rank is clicked to be opened when this operation is the first analysis. Then, since the button for starting “CAD-A” which is a tool for preparing the shape model is displayed on the screen, this button is clicked to start the “CAD-A”. The analysis executor uses the “CAD-A” to prepare the shape model of the structure to be analyzed. At this time, the analysis executor can use document preparation software, spreadsheet software, drawing software or the like to refer to a so-called knowhow (knowledge) described to be able to recognize peculiarity, attention in utilization and the like of the “CAD-A”. Accordingly, since the analysis executor can refer to experience of the user of the “CAD-A”, a failure in preparation of the shape model using the “CAD-A” can be reduced.

When the preparation of the shape model is completed, the view for the “CAD-A” is closed and a folder of “Preparation of Analysis Model” which is a next work item is clicked from the process template to be opened. Then, a start button of “Analysis Tool B” constituting an analysis model preparation tool linked thereto by the template preparation person is displayed and accordingly the start button is pressed to start the “Analysis Tool B”. The analysis model is a model at the preceding stage used to perform the analysis calculation using a finite element method or the like at the later stage by dividing the shape model which is an object to be analyzed finely (it is also said that the shape model is meshed or mesh is put on the shape model). The analysis executor utilizes the “Analysis Tool B” to perform the work that mesh is put on the shape model prepared by utilizing the “CAD-A”. The reason that the shape model data by the “CAD-A” of the preceding work is reflected to the “Analysis Tool B” at the later stage is as follows: The process template stores a storage address of the result data of the “CAD-A” in relation to the work item, that is, to the “Preparation of Shape Model” and the tool in the work item at the later stage is programmed to acquire desired data by accessing to the address in which the data produced by the tool at the preceding stage is registered while referring to a predetermined address of the work item at the preceding stage. Here, the “Analysis Tool B” at the later stage is opened to thereby take in the shape model data produced by the “CAD-A” at the preceding stage automatically.

The accuracy of the analysis calculation result at the later stage is influenced by the magnitude of mesh, how to set the boundary between meshes and the like. Accordingly, the work that the mesh is put on the shape model requires the skill of the analysis executor.

In the first and second methods described above, for example, the history of the work that the analysis executor puts the mesh on the shape model is not preserved. This reason is that the object to be analyzed is decided and the system sets up the purpose that the shape model of a desired object to be analyzed is inputted to thereby output the analysis result of the object to be analyzed fully automatically.

On the contrary, the purpose of the process template execution control unit of the embodiment is to store the work history utilizing a tool and its result in relation to the tool to thereby make it possible to store the knowhow automatically.

For example, as machine tools installed in a factory for manufacturing products, there are a lathe, a drill press, a miller, a grinder and the like, while the order of using these machines is various depending on an object to be manufactured. However, the respective machines have respective characteristics and the operator uses the machine efficiently to thereby store these characteristics as knowhow. In many cases, the knowhow is the characteristic peculiar to the machine but some is knowhow peculiar to an object to be manufactured. The knowhow is passed down from an operator to an operator. For example, when the processing procedure of a lathe is programmed, knowhow exists in the cutting down procedure or used tools and this is knowhow peculiar to the lathe. Regardless of the whole processes for manufacturing the object, even when the lathe is used in manufacture of a different object to be manufactured, the knowhow in the lathe can be often utilized.

The analysis work intended in the embodiment is also the same and the tools (software) used in respective items include knowhow peculiar thereto. Accordingly, for example, when mesh is put on the shape model which is the “Analysis Tool B”, operation itself (work history) of the “Analysis Tool B” is stored in relation to the “Analysis Tool B”, so that a portion that the analysis executor who will use it later can utilize can be copied or used as a model and accordingly the analysis work efficiency is expected to be increased.

The system described above is now described in detail with reference to the accompanying drawings.

1. System Configuration of the Invention

FIG. 1 is a schematic diagram illustrating an embodiment of an analysis work support system according to the present invention. The analysis work support system of the embodiment comprises an input/output unit 101 including a keyboard, a mouse, a display and the like used by the system user to input data and display it, a process template preparation unit 102 for defining a series of analysis work processes as process template data, a process template execution control unit 103 for leading analysis works on the basis of the process template data prepared by the process template preparation unit 102, a process template database 104 for storing process templates prepared and partially modified by the process template preparation unit 102 and the process template execution control unit 103, an engineering tool 105 including a prepost processor and analysis programs described in the process template prepared by the process template preparation unit 102, an analysis instance database 106 for storing result files produced by the engineering tool, a knowledge retrieval visualization tool 107 for visualizing analysis knowledge data such as analysis modeling knowhow and analysis result evaluation knowhow, a knowledge database 108 for storing analysis knowledge data and an execution control file database 109 for storing execution control files for automatically executing the engineering tool and the knowledge retrieval visualization tool on the basis of the analysis knowledge.

When the user of the system defines an analysis work process as a process template, the user uses the process template preparation unit 102 by means of the input/output unit 101 to prepare process template data.

On the other hand, when the analysis work is performed in accordance with the process template, the process template execution control unit 103 and the engineering tool 105 and the knowledge retrieval visualization tool 107 started and executed by the process template execution control unit 103 are used by means of the input/output unit 101.

2. Structure of Process Template

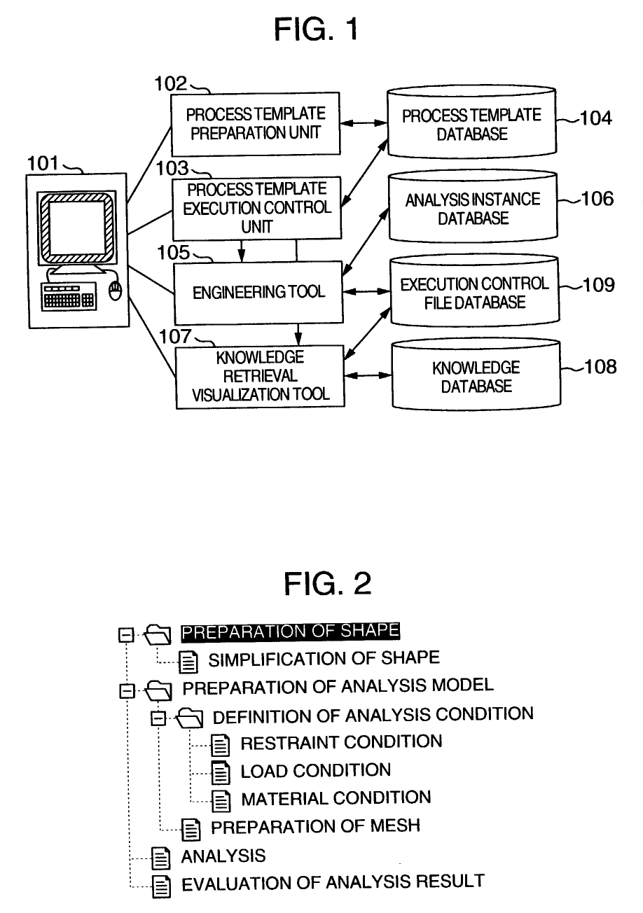

The process template data is described. FIG. 2 shows an example of the process template data. The process template data is expressed by an aggregate of a plurality of unit processes in which a series of analysis work processes are set in order. Each unit process can be further divided into aggregates of smaller unit processes and expressed thereby. That is, the process template data is the analysis procedure expressed by the aggregate of unit processes having a hierarchical structure set in order.

FIG. 2 shows an example of unit processes including “Preparation of Shape”, “Preparation of Analysis Model”, “Analysis” and “Evaluation of Analysis Result” inputted by the system user so that these unit processes are defined in the highest hierarchy. Further, the “Preparation of Shape” includes the unit process of “Simplification of Shape” defined in a lower-rank hierarchy and the “Preparation of Analysis Model” includes the unit processes of “Setting of Analysis Condition” and “Preparation of Mesh” defined in a lower-rank hierarchy. The “Setting of Analysis Condition” also includes a still lower-rank hierarchy similarly.

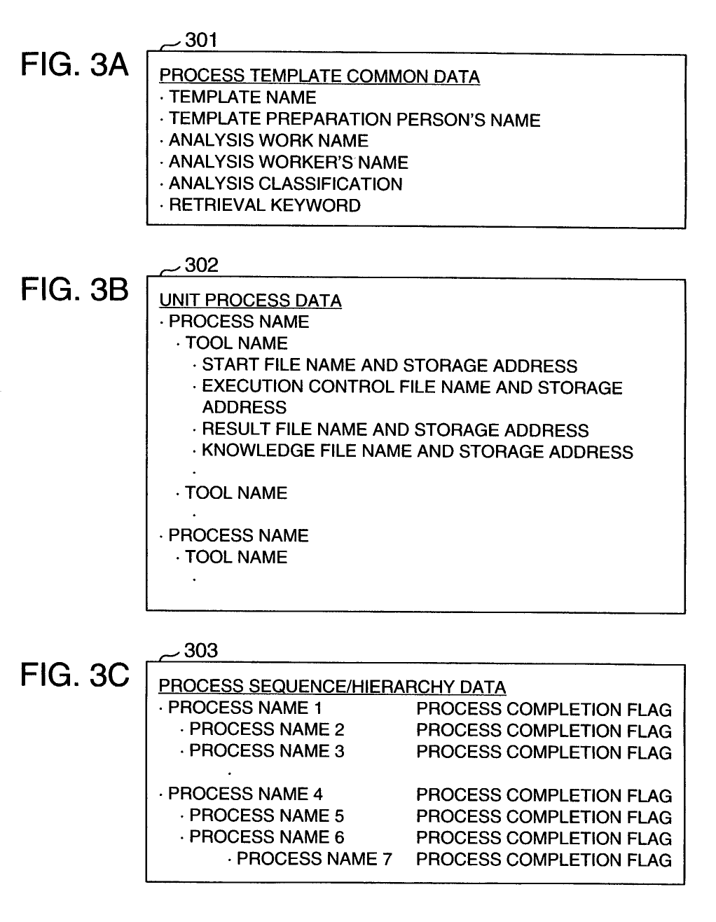

FIGS. 3A, 3B and 3C show an example of data structure of the process template. The data structure of the process template is broadly divided into three blocks.

The first block includes process template common data 301 (FIG. 3A) having items inputted by the template preparation person. The process template common data includes data such as template name, template preparation person's name, analysis work name, analysis worker name, analysis classification and retrieval keyword. The template name and the template preparation person's name are data inputted only when a process template is newly prepared by the process template preparation unit and cannot be changed by the process template execution control unit. This is made to the effect that the template preparation person's honor is respected as if it were likened to author's personal rights and retrieval is made correctly. Other data can be inputted and corrected by both of the process template preparation unit and the process template execution control unit.

The second block includes unit process data 301 (FIG. 3B), which is defined for each unit process which is the work item in the order set by the template preparation person. In the unit process data 302, tool names of an engineering tool, a knowledge retrieval visualization tool to be used or the like are described under the process name, and further a name of a start file in which a command for starting a tool is described and a storage address of the tool, a name of the execution control file (work history) in which a series of commands for automatically executing the tool is described and its storage address, a name of a result file outputted by the tool or a name of a knowledge file retrieved by the tool are described under each tool name. The result file name and the knowledge file name are data added even upon analysis work using the process template. The storage address of the result file is an address given to the tool used in the unit process at the next stage and the tool executes processing on the basis of data stored in this address.

The third block includes process sequence/hierarchy data 303 (FIG. 3C). In this block, data relative to the order that the unit processes described in the unit process data 302 are executed and the parent and child relationships among the unit processes are described. Further, a process completion flag described when the processing of the unit process is completed is set for each unit process. Consequently, even when the analysis work is interrupted on the way, the process template can reproduce the state upon interruption when the analysis work is resumed.

3. Execution of Tool and Automatic Storage of Analysis Instance Data

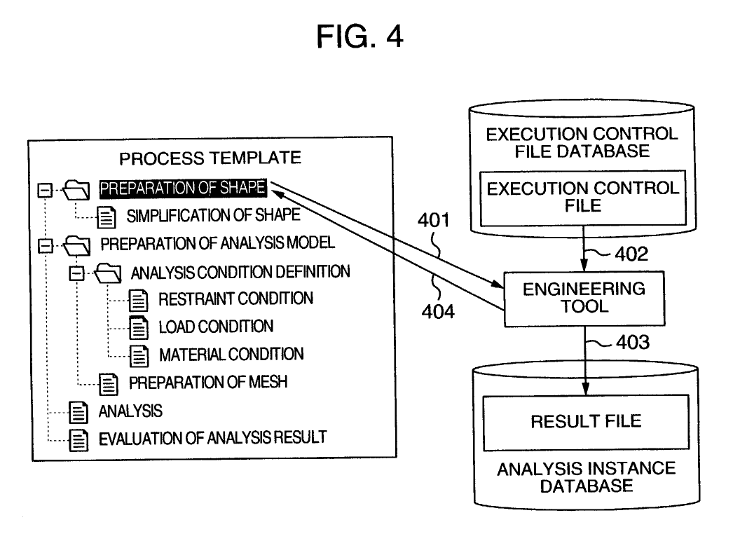

The mechanism of executing the engineering tool from the process template is first described. FIG. 4 shows the relationships among the process template, the engineering tool, the analysis instance database and the execution control file database (work history utilizing the engineering tool).

First, when the system user (analysis executor) designates a unit process (work item) of the process template, the process template execution control unit starts the engineering tool described in the unit process (401). At this time, when the execution control file for automatically executing the engineering tool is described in the designated template, the engineering tool is caused to read the execution control file so that automatic processing is made (402). After execution of the engineering tool, the result file is stored in the analysis instance database (403). Finally, data including the name of the result file stored in the analysis instance database and its storage address is delivered from the engineering tool to the process template and the data of the result file name and the storage address is entered in the designated unit process (404). On the other hand, when the execution control file for automatic execution is not described in the process template, data of work history that the engineering tool is operated interactively is left as the execution control file. The name and the storage address of the execution control file are also described in relation to the unit process designated by the process template when the engineering tool is ended.

The execution control file is to store the history of work done by using the engineering tool. More particularly, the history is a data row including commands used by the engineering tool and parameters inputted. For example, the command is “Preparation of Rectangular Parallelepiped” and the parameter is “5 cm in depth, 4 cm in width and 3 cm in height”. The execution control file is a file which is automatically prepared when the engineering tool is used and its storage address is written in the process template similarly to the word result data. Consequently, the execution control file already prepared is used to add some modification to the knowledge taken over from the ex-user so that the analysis time for the object that the system user desires to analyze can be reduced.

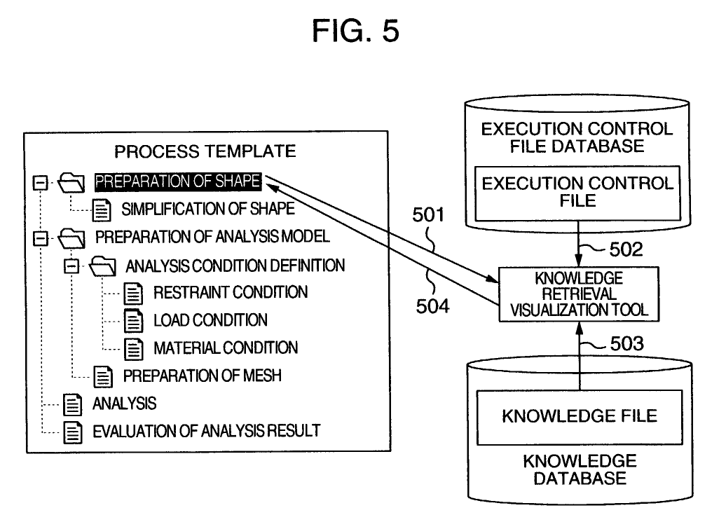

Next, the mechanism of executing the knowledge retrieval visualization tool from the process template is described. FIG. 5 shows the relationships among the process template, the knowledge retrieval visualization tool, the knowledge database and the execution control file database. This is a file described in the document preparation software, the spreadsheet software and a drawing software and understandable as characters, tables, graph and drawing by the operator.

First, when the system user (analysis executor) designates a unit process of the process template, the process template execution control unit starts the knowledge retrieval visualization tool described in the unit process (501). When the retrieving procedure of the knowledge data to be referred to is described as an automatic execution file, the execution control file is read in to perform automatic retrieval (502). When knowledge is retrieved newly, the started knowledge retrieval visualization tool retrieves a knowledge file from the knowledge database to refer to it (503). Finally, data including the name of the retrieved knowledge file and its storage address is delivered from the knowledge retrieval visualization tool to the process template and the data is entered in the designated unit process (504). On the other hand, when the execution control file for automatic retrieval is not described in the process template, data of work history that the knowledge retrieval visualization tool is operated interactively is left as the execution control file. The name and the storage address of the execution control file are also described in relation to the designated unit process of the process template when the knowledge retrieval visualization tool is ended.

The above processing is executed in accordance with the procedure defined in the process template to thereby make it possible to automatically store and manage the result file prepared by the engineering tool and the knowledge file retrieved by the knowledge retrieval visualization tool in relation to the process template.

The data itself of the process template is stored in the process template database. The stored process template can be retrieved using the process template common data shown in FIG. 3 as a keyword and can reuse as the process template to be similarity-analyzed.

4. Specific Example of Process Template

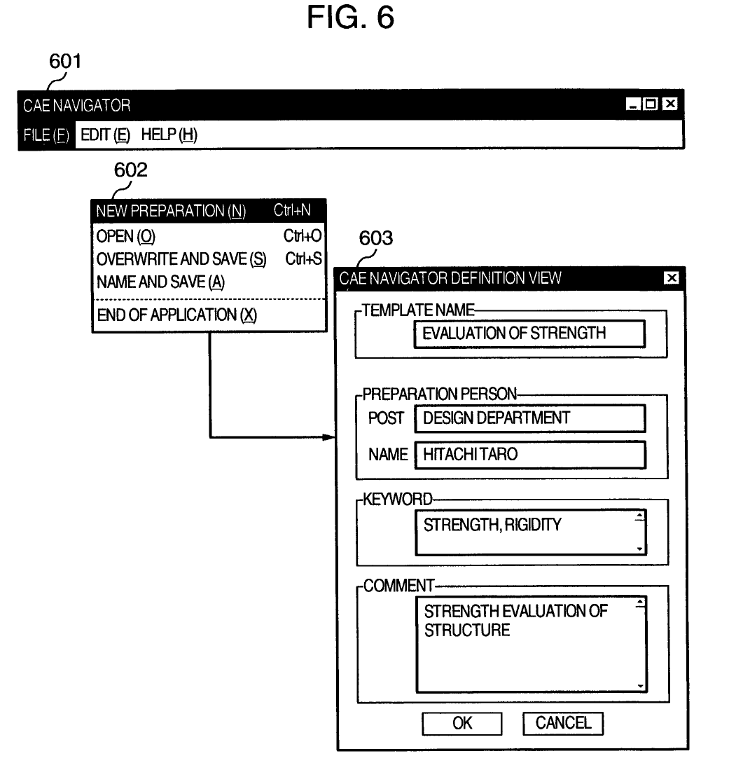

Referring now to FIGS. 6 to 8, a specific method of preparing the process template is described. When the template preparation person starts the process template preparation unit, the top menu 601 shown in FIG. 6 is displayed on the display screen. Then, when the person designates the file menu in the top menu and selects the new preparation in the pop-up menu 602, the view 603 for inputting the process template common data is displayed. In this view 603, a template name, a template preparation person's name, a keyword for retrieving the process template and the like are inputted.

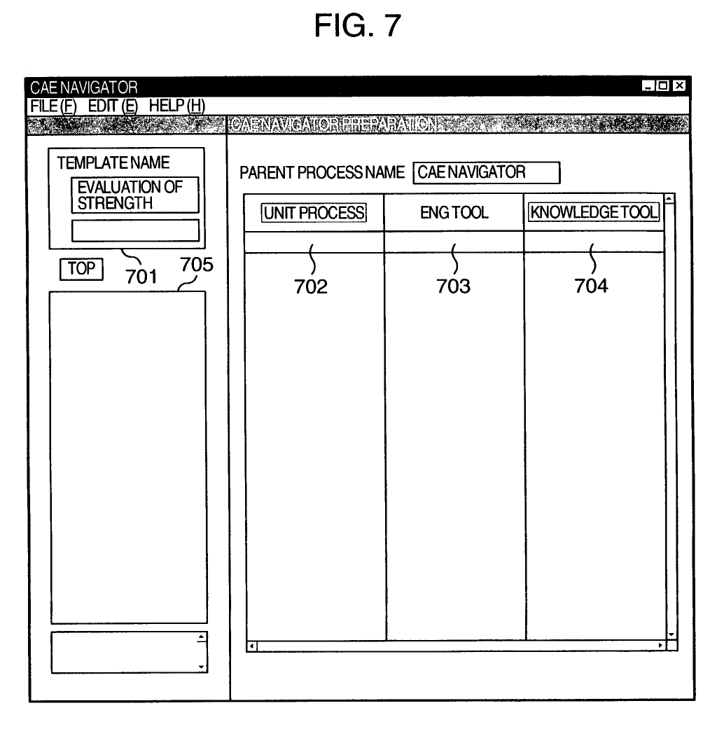

Then, when the input view 603 of the process template common data is closed, the process template input view as shown in FIG. 7 is displayed. In FIG. 7, numeral 701 represents the confirmation view of the inputted process template common data. Columns represented by numerals 702, 703 and 704 in the process template input view of FIG. 7 are inputted with a name of the unit process, a name of the engineering tool to be used and a name of the knowledge retrieval visualization tool to be used. At this time, when lists of the names of the engineering tolls and the knowledge retrieval visualization tools to be used are prepared, desired engineering tool and knowledge retrieval visualization tool can be selected from the lists displayed as the pop-up menu to be set in the process template input view.

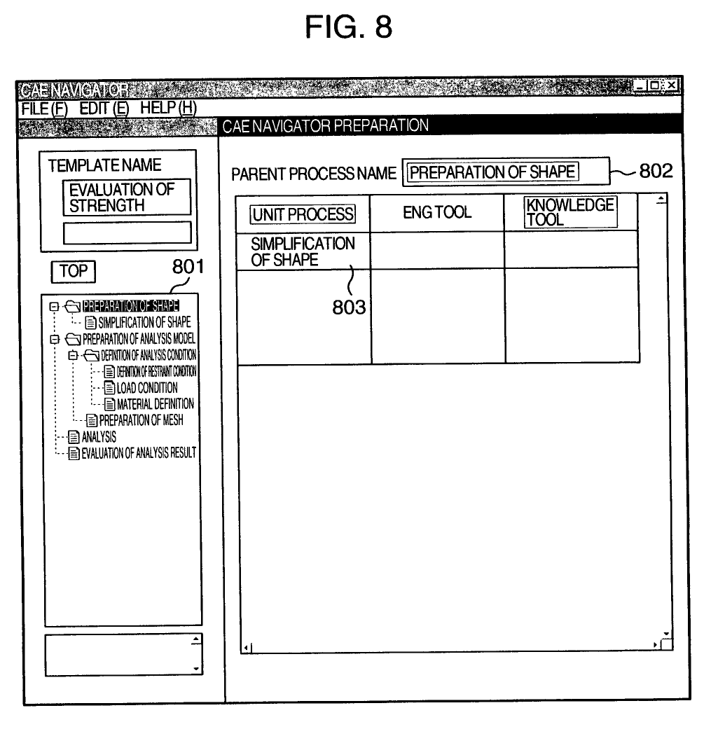

The inputted unit process is displayed in the process template confirmation view represented by 705. Similar operation is repeated to define the unit processes having the same hierarchy successively. For the unit process having a different hierarchy, when the unit process constituting a parent process is designated from the process template confirmation view 801 shown in FIG. 8, the parent process name designated in a parent process display column 802 is displayed in the process template preparation view and data for the unit process can be inputted from the unit process input picture 803. The example of FIG. 8 shows the state that the unit process of “Simplification of Shape” is inputted in a lower hierarchy of “Preparation of Shape”. Further, as other functions except the above, functions such as deletion, insertion and change of order of unit process are provided.

With the above-mentioned graphical input interface, a new process template can be prepared easily. Further, by editing the existing process template, time and labor for preparation can be omitted.

5. Specific Example of Execution of Process Template

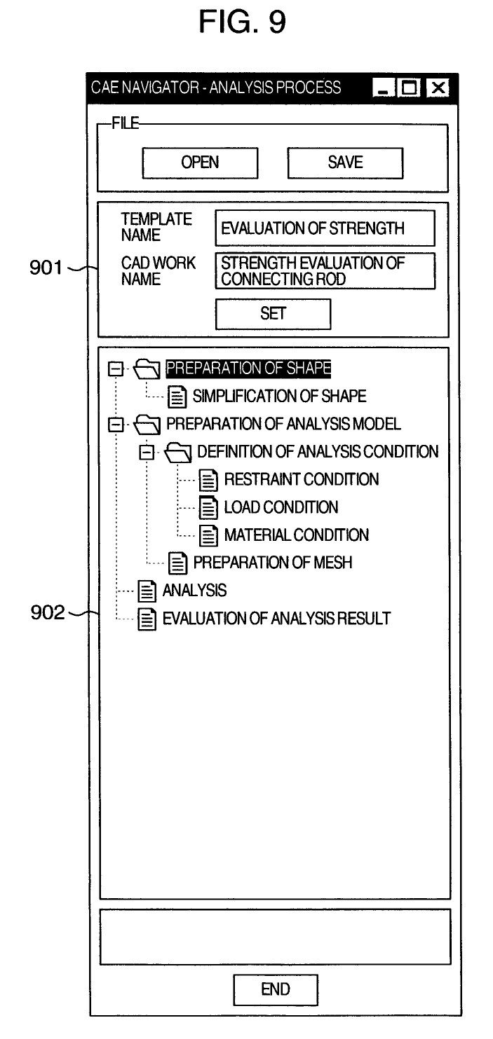

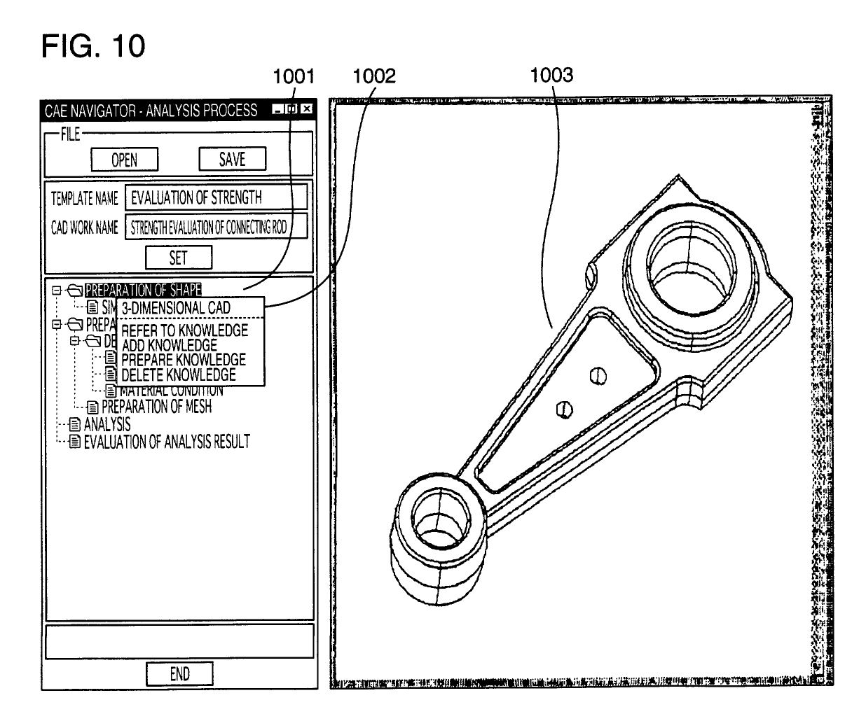

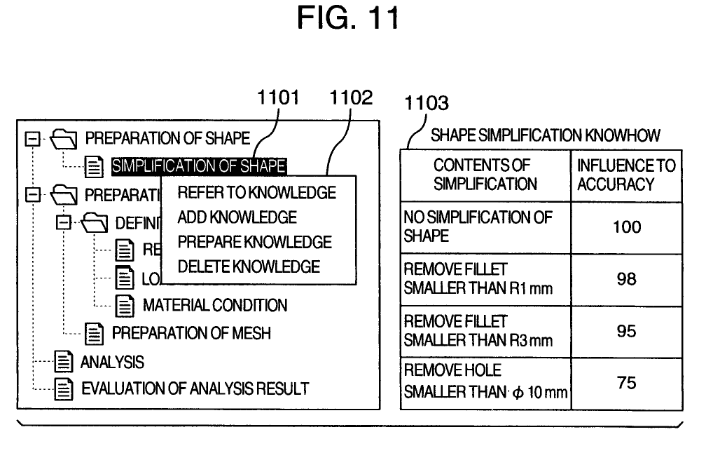

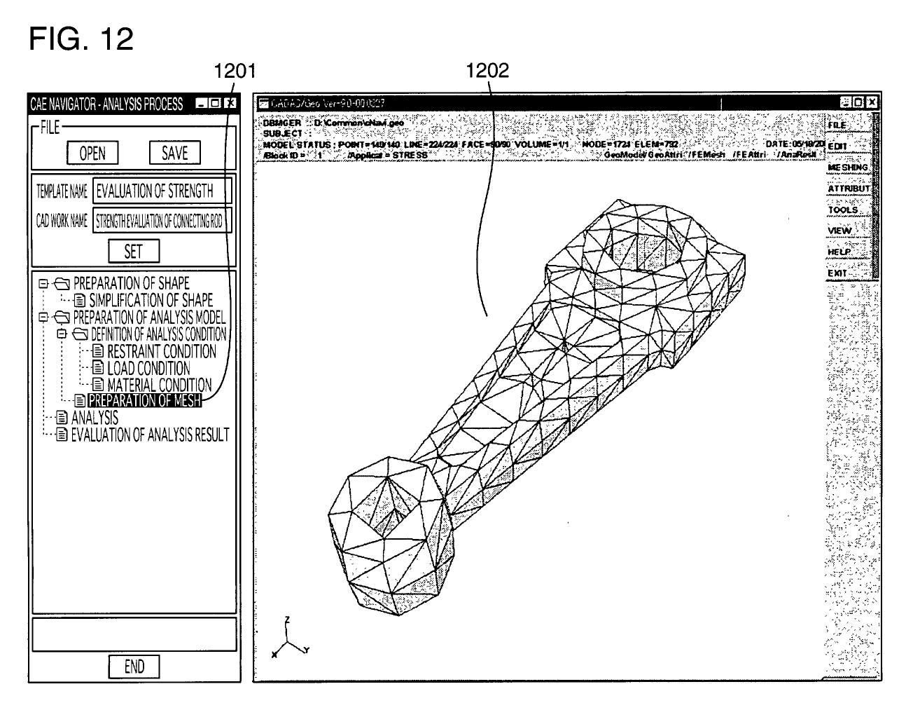

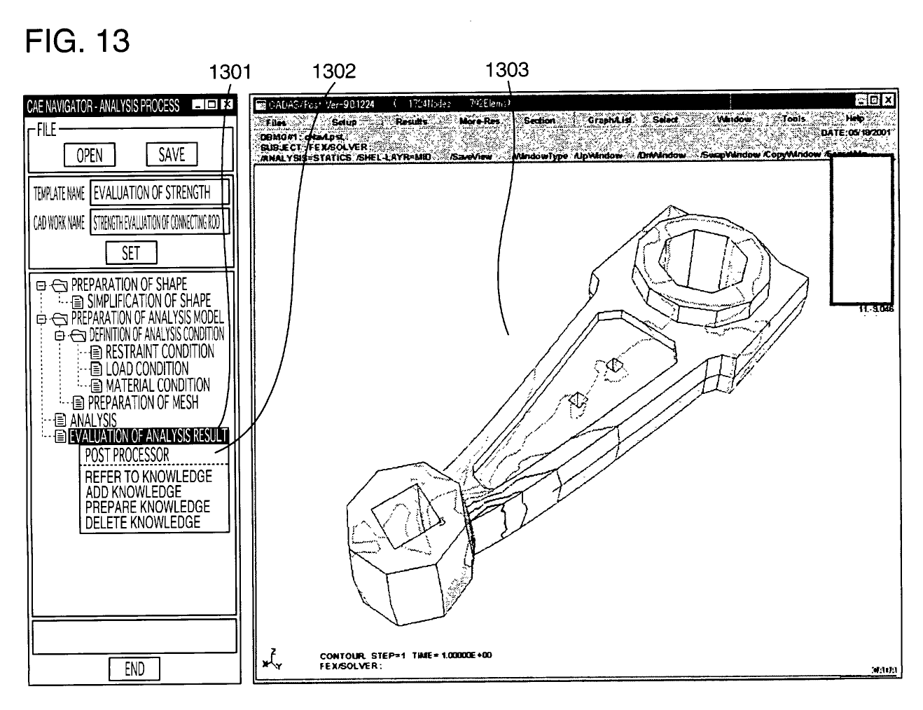

A specific example of the analysis work support utilizing the process template is now described with reference to FIGS. 9 to 13. When the system user (analysis executor) decides the process template to be used and starts the process template execution control unit, the process template execution view is displayed as shown in FIG. 9. When the process template is one used for the first time, the analysis work name and an analysis worker's name are inputted in a process template command data column 901. Next, the unit process to be worked is designated from a process template display view 902. FIG. 10 shows an example in which the unit process 1001 of “Preparation of Shape” is designated from the process template display view to display a pop-up menu 1002 from which a three-dimensional CAD is selected to be started so that a shape model 1003 to be analyzed is displayed. FIG. 11 shows an example in which a knowledge reference visualization tool 1102 linked to the unit process of “Simplification of Shape” is started to display knowhow 1103 of shape simplification on the display screen. The example of the shape simplification shown in FIG. 11 shows the influence degree of each shape simplification method to the analysis accuracy when the analysis accuracy in case of no shape simplification is 100. Further, in an example shown in FIG. 12, the unit process 1201 of “Preparation of Mesh is designated to automatically produce an analysis mesh 1202 by the execution control file which is previously set in the unit process. In this case, the size, roughness and fineness or the like of the mesh can be described in the execution control file to thereby produce the mesh suitable for the object to be analyzed. FIG. 13 also shows an example in which the unit process 1301 of “Evaluation of Analysis Result” and a post processor 1302 in the pop-up menu are designated to automatically display a stress distribution diagram 1303 on the display screen by the execution control file which is previously set in the unit process similarly to FIG. 12. The display method can be previously described to thereby automatically display a desired analysis result.

6. Flowchart of Process Template Preparation Unit

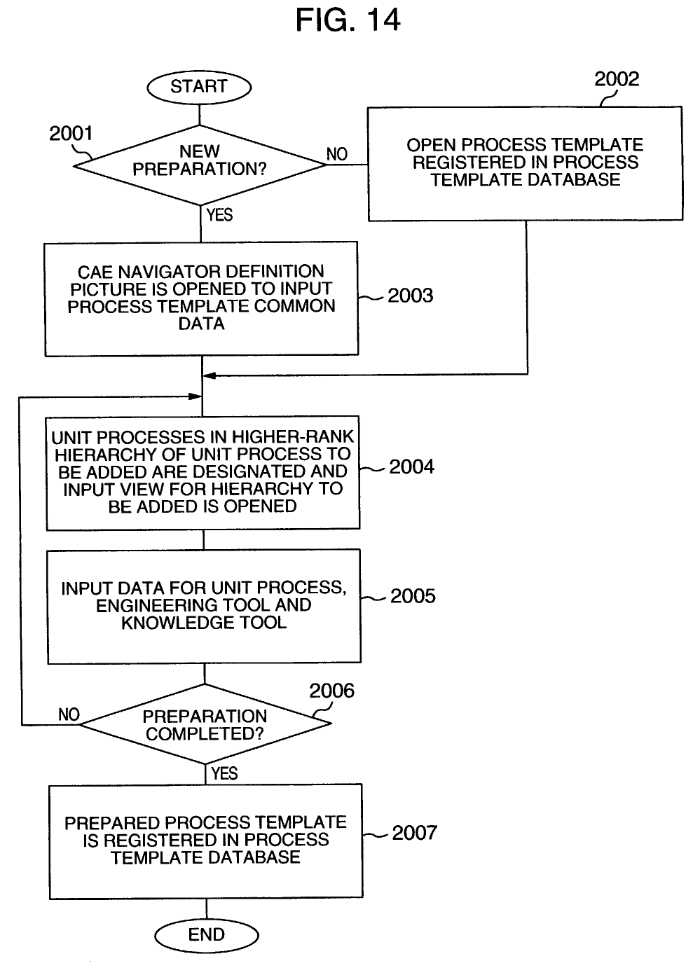

FIG. 14 is a flowchart showing operation of the process template preparation unit. When the process template preparation is started, it is inquired whether this process template preparation is new (2001) and when it is not new, the process template already registered is selected to be opened (2002). When it is new, the CAE navigator definition view (FIG. 6) is opened to enter a common data input mode (2003). When inputting of common data is ended, the process proceeds to inputting of the unit process (2004). In this step, when the preparation is new, the unit processes in the same hierarchy are inputted in order and when the inputting has been made already, the unit processes in the higher-rank hierarchy of the unit process to be added are designated and the input view for the hierarchy to be added is opened. When the input view is opened, data for the engineering tool and the knowledge are inputted in the linked manner to the unit process (2005). When the preparation is not completed responsive to an inquiry as to whether the preparation is completed or not, the process is returned to step (2004) and the inputting is further continued. When it is completed, the prepared process template is registered in the process template database (2007).

7. Flowchart of Process Template Execution Control Unit

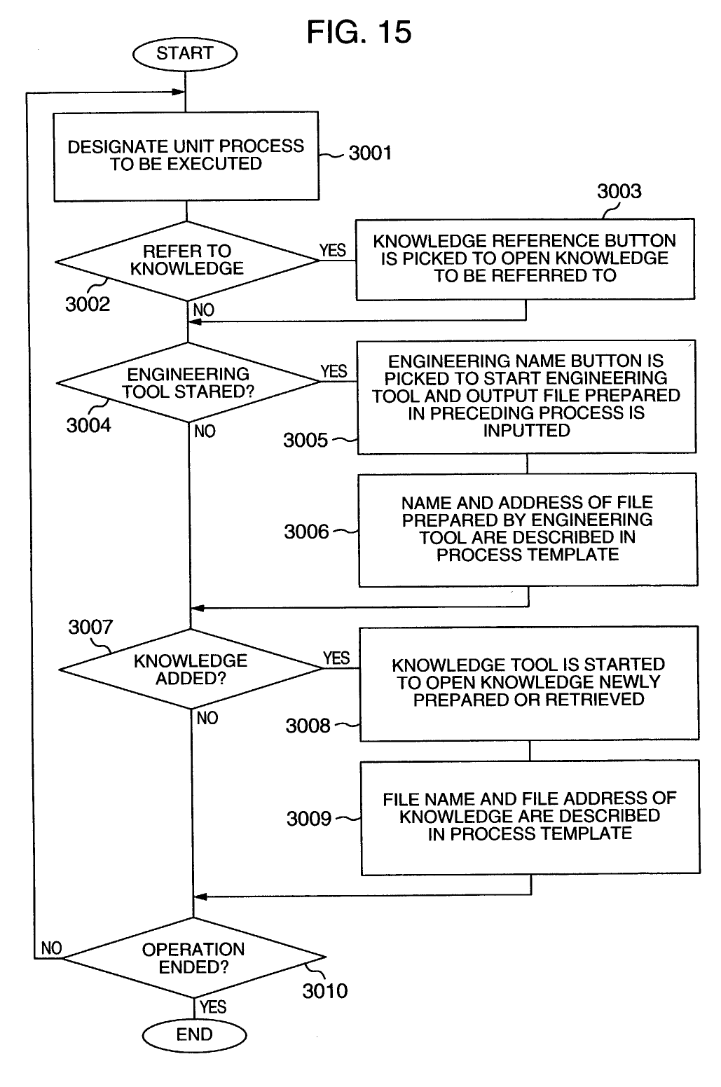

Referring now to FIG. 15, the flowchart of the process template execution control unit is described. When the process template is started and the unit process to be executed is designated (3001), a knowledge reference button is clicked (3002) to open the knowledge to be referred to (3003) when the knowledge is referred to. The engineering tool is started by a start button of the engineering tool (3004) and at the same time the output file (result file) prepared in the preceding process is read in (3005). The name and the address of the result file prepared by the engineering tool are described in the process template (3006). When knowledge is added newly (3007), the knowledge tool is started to open the newly prepared knowledge or retrieved knowledge to be inputted (3008). The file name and the file address of the inputted knowledge are registered in the process template (3009). When all operation is not ended, the process is returned to step (3001) and operation is continued (3010).

As described above, the analysis knowledge requiring the system user's judgment can be displayed on the screen by means of the knowledge retrieval visualization tool linked to the unit process. On the other hand, the procedure of the analysis knowledge which can be processed automatically can be described in the execution control file of the engineering tool to thereby realize automation of the analysis work. Further, when it is necessary for the system user to select the knowledge from the plurality of analysis knowledge items which can be processed automatically case by case, the analysis knowledge files and the execution control files are related to each other to be described in the process template, so that the analysis work can be automated by the execution control file corresponding to the selected knowledge file.

Further, the present system can be sold by loading the process template preparation unit and the process template execution control unit in a recording medium such as CD or DVD on condition that the process template preparation unit and the process template execution control unit are combined with each other or separated from each other. In addition, the present system can be sold through a network.

It should be further understood by those skilled in the art that although the foregoing description has been made on embodiments of the invention, the invention is not limited thereto and various changes and modifications may be made without departing from the spirit of the invention and the scope of the appended claims.

What is claimed is:

1. An analysis work support system comprising a function of inputting a plurality of unit processes relative to analysis work in accordance with an order intended by a preparation person and a function of inputting an engineering tool relative to said analysis work for each unit process.

2. The analysis work support system according to claim 1, comprising a function of further inputting a plurality of unit processes in a lower rank of said unit processes in accordance with an order intended by the preparation person.

3. An analysis work support system comprising a function of displaying a view for inputting a name of a template and a template preparation person's name, a function of displaying a view for inputting a name of a unit process for each unit process relative to analysis work, a function of displaying a plurality of tools each being related to a storage address and stored, as a pop-up menu on a screen, and a function of displaying a tool selected from said plurality of tools on the screen in relation to a unit process thereof.

4. An analysis work support program for realizing a function of inputting a plurality of unit processes relative to analysis work in accordance with an order intended by a preparation person and a function of inputting an engineering tool relative to said analysis work for each unit process.

5. The analysis work support program according to claim 4, realizing a function of further inputting a plurality of unit processes in a lower rank of said unit processes in accordance with an order intended by the preparation person.

6. An analysis work support program realizing a function of displaying a view for inputting a name of a template and a template preparation person's name, a function of displaying a view for inputting a name of a unit process for each unit process relative to analysis work, a function of displaying a plurality of tools each being related to a storage address and stored, as a pop-up menu on a screen, and a function of displaying a tool selected from said plurality of tools on the screen in relation to a unit process thereof.

7. An analysis work support system comprising a function of storing a plurality of unit processes displayed on a process template display view and storage addresses of work result data by a tool in which a program storage address is stored for each unit process and a function of, when a tool in a unit process next thereto is executed, providing to said tool in said next unit process an address in which said work result data by said tool is stored.

8. An analysis work support system comprising a function of storing a plurality of unit processes displayed on a process template display view and storage addresses of work history and work result data by a tool in which a program storage address is stored for each unit process and a function of, when a tool in a unit process next thereto is executed, providing to said tool in said next unit process an address in which said work result data by said tool is stored.

9. An analysis work support program realizing a function of storing a plurality of unit processes displayed on a process template display view and storage addresses of work result data by a tool in which a program storage address is stored for each unit process and a function of, when a tool in a unit process next thereto is executed, providing to said tool in said next unit process an address in which said work result data by said tool is stored.

10. An analysis work support program realizing a function of storing a plurality of unit processes displayed on a process template display view and storage addresses of work history and work result data by a tool in which a program storage address is stored for each unit process and a function of, when a tool in a unit process next thereto is executed, providing to said tool in said next unit process an address in which said work result data by said tool is stored.
